(19) United States
(12) Patent Application Publication
(10) Pub. No.: US 2003/0138209 A1
(43) Pub. Date: Jul. 24, 2003

(54) Filter device using thermo-optically controlled bragg grating

(76) Inventor: Edward Keat Leam Chan, Oakland, CA (US)

Correspondence Address: John E. Gunther, Digilens Inc, 615 Palomar Avenue, Sunnyvale, CA, 94086, US

(21) Appl. No.: 10/339,498

(22) Filed: Jan. 9, 2003

Related U.S. Application Data
(60) Provisional application No. 60/347,357, filed on Jan. 10, 2002.

(51) Int. Cl. G02B 6/34; G02B 6/26

(52) U.S. Cl. 385/37; 385/30

(57) ABSTRACT

An optical device directed at controlling wavelength transmission in a waveguide is disclosed. The basic device comprises a substrate containing an optical waveguide, a layer containing a grating, a variable refractive index layer and a set of electrodes for selectively applying a local temperature at points along the waveguide. The grating is disposed sufficiently close to the optical waveguide to be within the evanescent coupling field of the guided beam. The waveguide and variable index materials have significantly different thermo-optical coefficients of refractive index such that the differential thermal coefficient between the variable index material and the substrate can be used to vary the interaction strength between the guided wave and the grating. The grating may be formed as a phase grating within the variable index layer. Alternatively the grating and variable index medium may be in separate layers. The grating may be a surface relief grating backfilled with a variable index material. The grating may be configured as a chirped grating.

### RELATED APPLICATIONS

This application claims priority to the U.S. Provisional Application No. 60/347,357, filed Jan. 10, 2002, entitled “Dynamic Gain Equalizer Using Thermo-Optically Controlled Bragg Grating”.

### BACKGROUND OF THE INVENTION

This invention relates to a waveguide device for use in optical communication networks. Specifically, the present invention provides a method for controlling wavelength transmission in which the interaction of the waveguided mode with a grating is controlled by the differential thermo-optical change in refractive index between the waveguide core and a variable refractive index medium.

There is a need for efficient, cost effective means for controlling wavelength transmission in telecommunications devices for example in Dynamic Gain Equalizers (DGEs) and Optical Add Drop Multiplexers (OADMs). One well known method relies on the wavelength selective properties of Bragg reflection gratings as disclosed in U.S. Pat. No. 4,807,950 by Glenn et al in which Bragg reflection gratings are formed in the core of germanium doped fiber. One important class of devices rely on recording a Bragg grating in a polymer dispersed liquid crystal (PDLC) mixture to form an Electrically Switchable Bragg Grating (ESBG). The ESBG grating exhibits variable diffraction efficiency, which may be controlled by the magnitude of the electric field applied across the PDLC layer.

In general, the strength of the attenuation, reflection or transmission due to a Bragg grating, which can be in the core or in close proximity to the core, depends on the intensity of the interaction or overlap between the waveguide mode and the Bragg grating and on the strength of the grating itself (its index modulation). This interaction is typically controlled by adjusting the index modulation (contrast between the high index and low index regions in the grating) of the grating as described in U.S. Pat. No. 5,937,115 by Domash. In that patent, the index modulation of an ESBG is changed by switching the birefringence of Holographic Polymer Dispersed Liquid Crystal (HPDLC).

An alternate and potentially simpler method that can achieve the same effect is to control the average index of the entire grating. When the index of the grating layer is close to but less than the index of the waveguide core, the interaction is strong and Bragg coupling occurs. When the index of the grating layer is reduced, the interaction is weaker because the waveguide mode is suppressed such that the overlap between the waveguide mode and the grating layer is small. Even though the index modulation of the grating layer remains substantially unchanged, the grating coupling is substantially reduced.

The use of thermo-optical effects to control refractive index is known in the art. For example U.S. Pat. No. 6,303,040 by Oh et al uses a polymer waveguide with a grating recorded in a high index polymer cladding. The wavelength tuning relies on both the core and cladding indices changing significantly with temperature while the coupling/interaction strength remains the same. The latter is demonstrated in FIG. 2 in Oh's patent that shows that the reflection strength is the same as the wavelength is tuned.

U.S. Pat. No. 6,011,881 by Moslehi discloses a tunable filter with a grating in proximity to and interacting with a variable index material. The grating may be in the core or in the cladding. Once again, however, the goal is to achieve wavelength tuning by changing the refractive index of both the core and grating. FIG. 5 and FIG. 7 of that patent show the wavelengths moving around with the peak heights remaining the same.

U.S. Pat. No. 6,303,040 by Oh et al also discloses the method of back-filling a relief grating with polymer. Again the wavelength tuning mechanism is based on both the core and the cladding indices changing significantly with temperature while the coupling/interaction strength remains the same.

However, while the ability to tune wavelength without varying reflection strength is useful for many applications—there are other applications in which it is desirable for filters to provide variable reflection at a particular wavelength. Therefore it would be desirable to provide a thermo-optic filter which can provide a variable reflection at a particular wavelength. In this way, particular wavelengths or channels can be filtered individually without having to tune the filter across wavelengths or channels that should be left unperturbed—this is known as “hitless tuning” in the field.

The object of the present invention is to obviate some of the limitations of the prior art by using the differential thermal coefficient of refractive index between the core and overcladding regions to vary the interaction strength between the guided mode and grating. A further object of the present invention is to provide an embodiment in which both the average index, and the index modulation can be varied.

### SUMMARY OF THE INVENTION

The invention is a switchable waveguide device directed at controlling wavelength transmission. The basic device comprises a substrate over which are deposited an optical waveguide having an input end for receiving light and an output end for outputting said light, a layer containing a grating and a variable refractive index layer. A plurality of electrodes is provided for selectively applying a local temperature at points along the waveguide. The grating is disposed sufficiently close to the said optical waveguide to be within the evanescent coupling field of the guided beam. The waveguide and overcladding layer materials have significantly different thermo-optical coefficients of refractive index such that varying the temperature will vary the interaction strength between the guided wave and the grating.

In a preferred embodiment of the invention the grating is formed as a phase grating within the variable index layer such that the grating and variable index material both have thermo optical coefficients substantially higher that those of the waveguide material.

In an alternative preferred embodiment the grating and the variable index layer are in separate layers with the variable index layer having thermo optical coefficients substantially higher than those of the waveguide material.

In a further alternative preferred embodiment of the invention the grating may be a surface relief grating backfilled with a variable index material where the variable index material has a thermo optical coefficient substantially higher than that of the waveguide. In a further alternative preferred embodiment of the invention the grating may be a surface relief grating backfilled with a variable index material where the variable index material has a thermo optical coefficient substantially higher than that of both the waveguide and surface relief grating.

In any of the preferred embodiments the grating may be configured as a chirped grating.

In any of the preferred embodiments a multiplicity of electrodes may be used to apply a thermal gradient along the waveguide.

A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

### BRIEF DESCRIPTION OF THE DRAWINGS

FIG. 1A is a schematic cross section of a first embodiment of the present invention comprising a waveguide, a variable index layer into which a grating has been recorded, a cover and a set of electrodes.

FIG. 1B is a schematic side view of a first embodiment of the present invention comprising a waveguide, a variable index layer into which a grating has been recorded, a cover and a set of electrodes.

FIG. 2A is a schematic cross section of a second embodiment of the present invention comprising a waveguide, a variable index layer, a grating, a cover and a set of electrodes.

FIG. 2B is a schematic side view of a second embodiment of the present invention comprising a waveguide, a variable index layer, a grating, a cover and a set of electrodes.

FIG. 3 is a chart illustrating strength of Bragg coupling versus wavelength by adjusting the average refractive index of the overlay at different temperatures.

FIG. 4A is a schematic cross section of a third embodiment of the present invention comprising a waveguide, a variable index layer, a chirped grating, a cover and a set of electrodes.

FIG. 4B is a schematic side view of a third embodiment of the present invention comprising a waveguide, a variable index layer, a chirped grating, a cover and a set of electrodes.

FIG. 5 is a chart illustrating the attenuation versus wavelength of a dynamic gain equalizer with the temperature adjusted locally at four different locations.

FIG. 6A is a schematic cross section of a fourth embodiment of the present invention comprising a waveguide, a surface relief grating filled with a polymeric material, a cover and a set of electrodes.

FIG. 6B is a schematic side view of a fourth embodiment of the present invention comprising a waveguide, a variable index layer, a chirped grating, a cover and a set of electrodes.

### DETAILED DESCRIPTION OF THE INVENTION

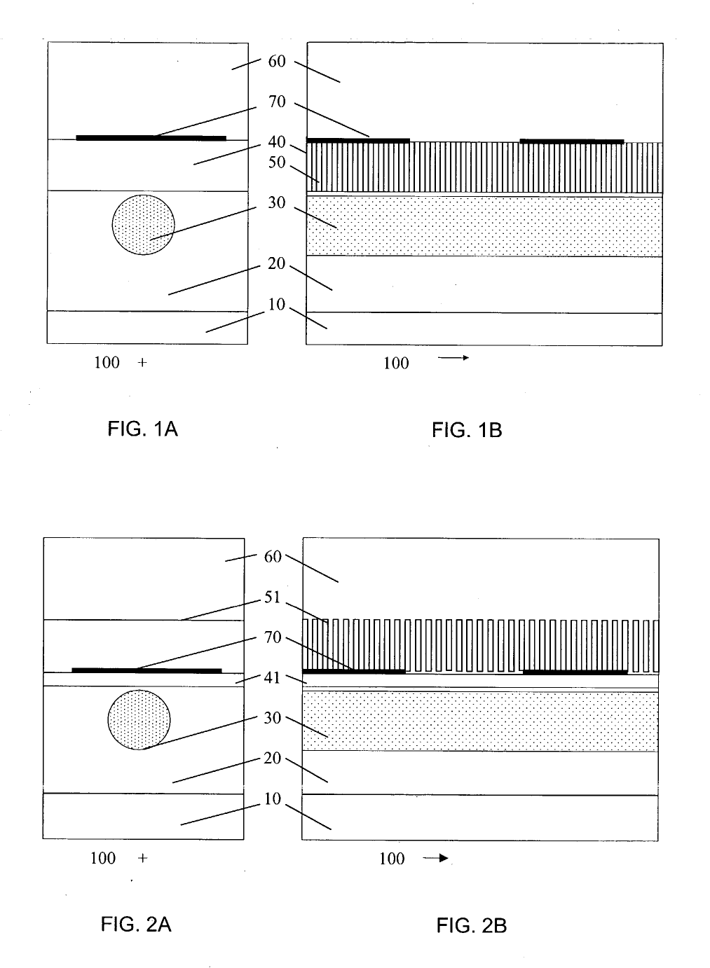

FIGS. 1A and IB show a cross section and side view respectively of a schematic representation of an optical device according to the basic principles of the invention. Referring to FIGS. 1A to 1B, the device comprises a substrate 10, a bottom cladding layer 20, an optical waveguide core 30 formed in or on a cladding material 20, an overcladding layer 40 containing a Bragg grating 50, disposed in proximity to the waveguide core, a cover 60 in contact with the cladding layer 40 and a multiplicity of electrodes 70 for selectively applying a local temperature at points along the overcladding, the electrodes being deposited on the inner surface of the cover layer. The light propagates in the direction 100. The substrate 10 would typically be fabricated from silicon. The optical waveguide may be totally immersed in the bottom cladding layer as shown in FIG. 1A and FIG. 1B or, alternatively, may have its core partially exposed and in direct contact with the overcladding layer. However, in order that optical waves be confined to the core, the optical refractive index of core 30 must be higher than that of the bottom cladding layer and the overcladding layer. The waveguide may have circular cross-section as shown in FIG. 1A or, alternatively, may have a rectangular cross section.

The core 30 and overcladding layer 40 materials are chosen to have significantly different thermo-optical coefficients such that the differential thermal coefficient can be used to control the interaction strength of the grating with the waveguide core. Typically, glass, which has a relatively small thermo-optic coefficient, would be used for the waveguide core and bottom cladding layer. Advantageously, the waveguide is fabricated on a good thermal conductor, such as silicon, to ensure good thermal isolation between the electrodes. Advantageously, the temperature of the silicon substrate would be maintained at a constant level using a Thermo Electric Cooler. Advantageously, the refractive index of the grating should be slightly lower than that of the waveguide cladding to achieve sufficient grating interaction yet prevent broadband losses.

In FIGS. 1A to 1B the grating is contained in the variable index overcladding layer. However, the grating may be in a separate layer as in the alternative embodiment of the invention shown in FIGS. 2A to 2B, which is generally similar to that of FIG. 1A to 1B and therefore similar parts are accorded the same reference numerals. In FIGS. 2A to 2B, the grating 51 is formed in the cover 60. The grating 51 is roughly the same distance from the core as the grating 50 of FIGS. 1A to 1B. However, the thickness of the overcladding layer 41 is less than the thickness of the overcladding layer 40 in FIGS. 1A to 1B. The cover could be germanium-doped silica as is typically used to make fiber Bragg gratings or a polymer. The overcladding layer 41 is now a homogeneous refractive index medium used to control the interaction of the waveguide mode with the grating in the cover, according to the basic principles described earlier. Again, the core 30 and overcladding layer 41 materials are chosen to have significantly different thermo-optical coefficients of refractive index such that the differential thermal coefficient can be used to control the interaction strength of the grating with the waveguide core.

The basic principles of the invention are now discussed with respect to the embodiment of FIG. 1. According to well known principles of waveguide optics, the strength of interaction between the grating and a beam mode propagating in the waveguide depends on the overlap between the waveguide mode and the grating layer. When the index of the overcladding layer 40 is close to but less than the index of the waveguide core, the interaction is strong and Bragg coupling occurs i.e. the mode expands toward the grating and the overlap increases. When the index of the grating layer is reduced, the interaction is weaker because the waveguide mode is suppressed such that the overlap between the waveguide mode and the grating layer is small. Even though the index modulation of the grating layer remains substantially unchanged, the grating coupling is substantially reduced.

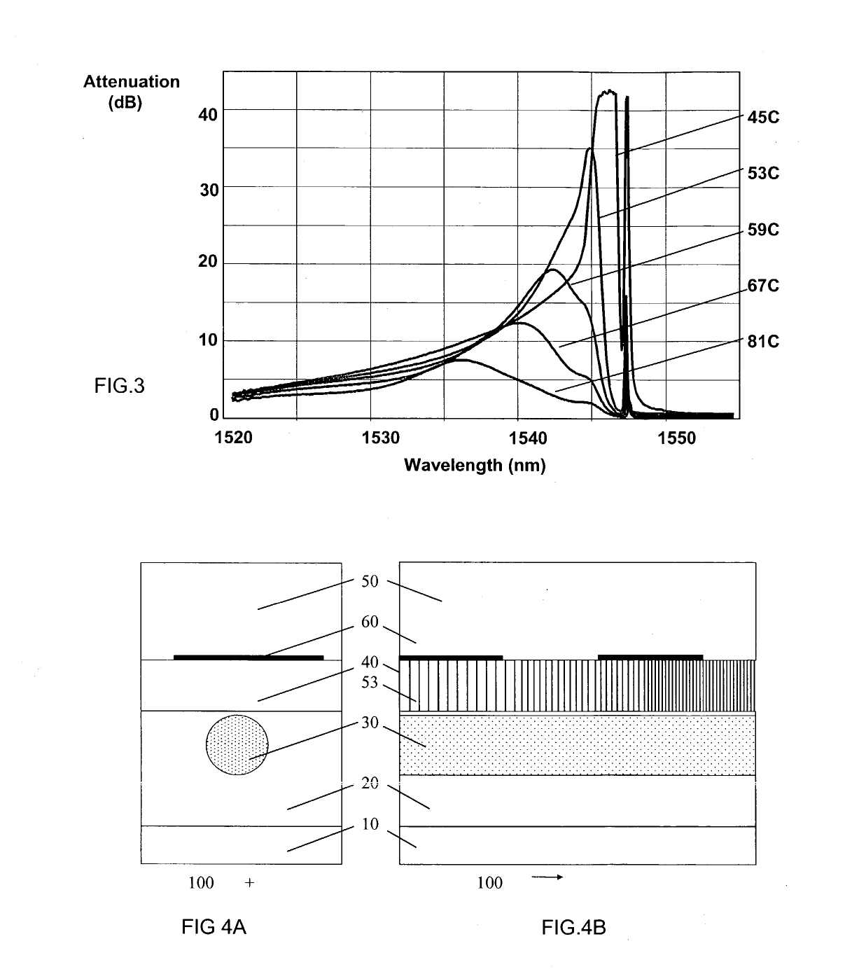

FIG. 3 shows the spectral response of a device according to the principles of FIG. 1A to FIG. 1B, consisting of a polymer over-cladding containing a phase grating on top of a silica waveguide. The polymer grating, made up of a combination of an epoxy and an acrylate, is exposed by holographic means to form a Bragg grating with a pitch of approximately 0.51 microns. The average index of the polymer is adjusted by controlling the temperature of the device. At 45° C., the device exhibits large attenuation. As the temperature is increased, the attenuation level decreases with a temperature increase of about +36° C. reducing the attenuation from 43 dB to 7 dB. The average refractive index of the polymer changes by about −3.5×10⁻⁴/° C. whereas the refractive index of the silica waveguide core and bottom cladding changes by only about +1×10⁻⁵/° C. Thus a +36° C. temperature change corresponds to a change in average refractive index of −0.013 in the polymer but only a change of +0.00036 in the waveguide core and cladding. The reduction in the average index of the polymer weakens the interaction between the grating and the waveguide, thus reducing the attenuation level. The index modulation of the grating does not vary substantially with temperature. Since the index of the waveguide core and cladding do not vary substantially, the mode index remains substantially unchanged, confining the interaction to a narrow spectral region around a particular wavelength.

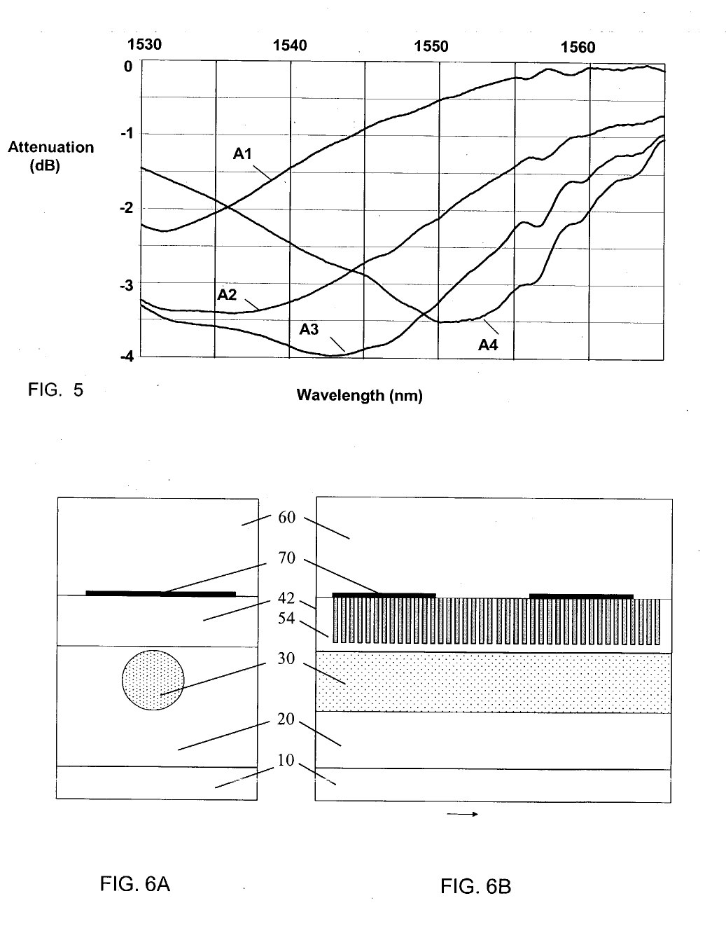

In a further embodiment of the invention the grating may be a chirped grating, as shown schematically in FIGS. 4A to 4B, which is generally similar to that of FIGS. 1A to 1B and therefore similar parts are accorded the same reference numerals. Typically, the Bragg grating 53 is linearly chirped. However, the chirp can be arbitrarily adjusted to allow customized compensation of specific spectral profiles. In a yet further embodiment of the invention a set of individually addressable electrodes could be used to impose a thermal gradient along the grating, such that the attenuation level at a given wavelength due to the Bragg grating can be adjusted by adjusting the temperature at the location on the waveguide with pitch corresponding to the desired wavelength. It will be clear that such a device can be configured to function as a dynamic gain equalizer. FIG. 5 shows the spectral profile of a prototype of such a dynamic gain equalizer with the temperature adjusted locally at four different locations along the grating, as illustrated by the plots A1 to A4. The attenuation is referenced to the initial state (i.e. before the local temperature adjustments were applied).

Although the embodiments of FIGS. 1A to 1B, FIGS. 2A to 2B, and FIGS. 4A to 4B use phase Bragg gratings, it is also possible to have surface relief gratings backfilled with polymeric material as shown in FIGS. 6A to 6B. Typically, the relief grating material 42 is silica. The backfilled regions of the grating are indicated by the shaded areas 54. With regard to the backfilling of surface relief gratings, it is once again important to emphasize that the present invention exploits the differential thermal coefficient between the relief grating material and the polymer to vary the interaction strength between the core and grating. The use of a backfilled relief grating has the advantage that both the average index and the refractive index modulation of the grating can be varied since both parameters are affected by the differential thermal coefficient.

It will be clear that the basic invention can provide a wide range of optical devices. directed at controlling the attenuation, transmission or reflection of light at specific wavelengths such as dynamic gain equalizers, reconfigurable add-drop multiplexers and dispersion compensators, for example.

The grating can be recorded into any material which will form a grating when exposed to a holographic pattern and which has a refractive index that can be modified easily. In the preferred embodiments of the invention, the gratings are fabricated by mixing two different components having substantially different polymerization kinetics. When the two components are mixed thoroughly and exposed to ultraviolet light, the fast curing monomer is polymerized much faster than the slow curing monomer mixture and quickly phase separates resulting in a concentration gradient. The concentration gradient gives rise to fixed changes in refractive indices and hence, to the formation of a permanent grating.

The preferred grating recording material is a combination of a faster curing acrylate monomer mixture and a slower curing commercially available epoxy monomer. The acrylate mixture is 90% 2-phenoxyethyl acrylate (SR339 from Sartomer, Inc.), 8% ethoxylated-3-bisphenol-A-diacrylate (SR349 from Sartomer, Inc.) and 2% Darocur 4265 photoinitiator (from Ciba Specialty Chemicals). The pre-mixed acrylate components are then combined with the slow curing epoxy monomer (C2361, available from NTT) in the ratio by weight of 1:1. The liquid recording material is introduced by capillary action into a thin cell formed by the waveguide substrate and the cover. Means of forming thin cells, including the use of spacer beads to maintain the desired cell thickness, are well known in the liquid crystal industry. The recording material is then cured using two coherent beams from a UV laser at a wavelength of 363.8 nm. The average refractive index of the completed grating is about 1.501 at room temperature, which is well suited for use with ion-exchanged glass waveguides having a core refractive index of 1.510. The thermo-optic coefficient of refractive index of the grating is about 3-4×10⁻⁴ per degree C.

Other recording materials that may be suitable for use in the present invention are described in U.S Pat. Nos. 6,165,648 and 5,874,187 and in “Epoxy Resin—Photopolymer Composites for Volume Holography,” Chemical Materials Volume 12, pages 1431-1438, 2000.

Whereas the invention has been described in relation to what are presently considered to be the most practical and preferred embodiments, it will be apparent to those skilled in the art that the invention is not limited to the disclosed arrangements but rather is intended to cover various modifications and equivalent construction included within the spirit and scope of the invention.

The core of the waveguide, which may be circular or rectangular in cross section, is so disposed that it has a surface thereof exposed at the bottom surface of the overcladding. However it is possible to use instead a waveguide of the type wherein the core is completely exposed such that it forms a ridge. Alternatively, the core can be buried slightly below the surface of the overcladding. However, in all cases some portion of the guided mode field overlaps the grating.

What is claimed is:

1. A switchable waveguide component comprising
an optical waveguide disposed on a substrate, said waveguide comprised of at least one core having an input end for receiving light and an output end for outputting said light and cladding;
a layer containing at least one grating disposed sufficiently close to said optical waveguide to be within the evanescent coupling field of said light;
a variable refractive index layer in proximity and optically interacting with said waveguide and said grating; and
a multiplicity of electrodes for selectively applying a local temperature at points along the overcladding;
wherein said variable refractive index layer has a substantially different thermo-optical coefficient of refractive index compared to said substrate, waveguide core, and waveguide cladding.

2. A component as claimed in claim 1 wherein said at least one grating is a surface relief grating and said variable index layer is backfilled into the grating.

3. A component as claimed in claim 2 wherein said variable index material has a thermo optical coefficient substantially higher than that of the waveguide.

4. A component as claimed in claim 2 wherein said variable index material has a thermo optical coefficient substantially higher than that of both the waveguide and surface relief grating.

5. A component as claimed in claim 1 wherein said at least one grating and said variable index layer are combined.

6. A component as claimed in claim 1 wherein said at least one grating is chirped.

7. A component as claimed in claim 1 wherein said component is configured as a dynamic gain equalizer.

8. A component as claimed in claim 1 wherein said component is configured as a reconfigurable optical add drop multiplexer.

9. A component as claimed in claim 1 wherein said component is configured as a tunable dispersion compensator.

10. A method of fabricating a switchable waveguide component comprising the steps of:
providing a substrate;
forming an optical waveguide, comprised of at least one core and cladding, disposed on said substrate;
forming a variable refractive index layer having substantially different thermo-optical coefficients of refractive index compared to said waveguide core and cladding;
forming at least one grating within said variable refractive index layer disposed sufficiently close to said optical waveguide to be within the evanescent coupling field of said light;
providing a cover; and
forming a multiplicity of electrodes for selectively applying a local temperature at points along said overcladding on the lower surface of said cover.

11. A method of fabricating a switchable waveguide component comprising the steps of:
providing a substrate;
forming an optical waveguide, comprised of at least one core and cladding, disposed on said substrate;
forming a variable refractive index layer having substantially different thermo-optical coefficients of refractive index compared to said waveguide core and cladding layers;
providing a cover;
forming at least one grating in said cover layer disposed sufficiently close to said optical waveguide to be within evanescent coupling field of said light; and
forming a multiplicity of electrodes for selectively applying a local temperature at points along said overcladding on the lower surface of said cover.

12. A method of fabricating a switchable waveguide component comprising the steps of:
providing a substrate;
forming an optical waveguide, comprised of at least one core and cladding, disposed on said substrate;
providing a layer containing at least one surface relief grating disposed sufficiently close to said optical waveguide to be within evanescent coupling field of said light;
backfilling said grating with a variable refractive index material;
providing a cover; and
forming a multiplicity of electrodes for selectively applying a local temperature at points along said surface relief grating on the lower surface of said cover.

13. A method as claimed in claim 12 wherein said variable index material has a thermo optical coefficient substantially higher than that of the waveguide.

14. A method as claimed in claim 12 wherein said variable index material has a thermo optical coefficient substantially higher than that of both the waveguide and surface relief grating.
